(19) United States
(12) Patent Application Publication
(10) Pub. No.: US 2016/0032862 A1
(43) Pub. Date: Feb. 4, 2016

(54) SYSTEM AND METHOD FOR REDUCED CREVICE VOLUME OF A PISTON CYLINDER ASSEMBLY

(71) Applicant: General Electric Company, Schenectady, NY (US)

(72) Inventors: Richard John Donahue, West Bend, WI (US); Mike Lawrence Youakim, Dousman, WI (US)

(21) Appl. No.: 14/448,685

(22) Filed: Jul. 31, 2014

(51) Int. Cl. F02F 11/00; F02F 1/00

(52) U.S. Cl. CPC F02F 11/002; F02F 11/005; F02F 1/004

(57) ABSTRACT

A reciprocating engine includes a cylinder head, a cylinder liner, an outer seal, and an inner seal. The cylinder liner has a flange proximate to the cylinder head, where the cylinder liner extends circumferentially around a combustion chamber, and the cylinder head defines an end of the combustion chamber. The outer seal is disposed between the flange of the cylinder liner and the cylinder head, where the outer seal is configured to transfer an axial compressive load between the cylinder head and the cylinder liner. The inner seal is disposed between the cylinder liner and the cylinder head proximate to the combustion chamber. The inner seal is configured to isolate an inner face of the outer seal from the combustion chamber. A first compressive strength of the outer seal is greater than a second compressive strength of the inner seal.

### BACKGROUND

The subject matter disclosed herein relates generally to reciprocating engines, and, more particularly to reduced a crevice volume of a piston cylinder assembly of a reciprocating engine.

A reciprocating engine (e.g., an internal combustion engine) combusts fuel with an oxidant (e.g., air) to generate hot combustion gases, which in turn drive a piston (e.g., a reciprocating piston) within a cylinder liner. In particular, the hot combustion gases expand and exert a pressure against the piston that linearly moves within the cylinder liner during an expansion stroke (e.g., a down stroke). The piston converts the pressure exerted by the combustion gases and the piston's linear motion into a rotating motion (e.g., via a connecting rod and a crankshaft coupled to the piston) that drives a shaft to rotate one or more loads (e.g., an electrical generator). The design and configuration of the piston and cylinder liner can significantly impact emissions (e.g., nitrogen oxides, carbon monoxide, etc.), as well as oil consumption. Gaps or crevices near the combustion chamber may retain incompletely combusted fuel and air, thereby increasing emissions or reducing combustion efficiency.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a reciprocating engine includes a cylinder head, a cylinder liner, an outer seal, and an inner seal. The cylinder liner includes an inner wall extending circumferentially around a cavity within the cylinder liner, an outer wall extending circumferentially around the inner wall, and a flange proximate to the cylinder head. The flange extends radially between the inner wall and the outer wall. The outer seal is proximate to the outer wall and is disposed axially between the flange of the cylinder liner and the cylinder head. The outer seal interfaces with the flange and the cylinder head. The inner seal is proximate to the inner wall and is disposed axially between the flange of the cylinder liner and the cylinder head. The inner seal interfaces with at least one of the flange and the cylinder head, and the outer seal is configured to transfer more of an axial compressive load between the cylinder head and the flange than the inner seal.

In a second embodiment, a reciprocating engine includes a cylinder head, a cylinder liner, an outer seal, and an inner seal. The cylinder liner has a flange proximate to the cylinder head, where the cylinder liner extends circumferentially around a combustion chamber, and the cylinder head defines an end of the combustion chamber. The outer seal is disposed between the flange of the cylinder liner and the cylinder head, where the outer seal is configured to transfer an axial compressive load between the cylinder head and the cylinder liner. The inner seal is disposed between the cylinder liner and the cylinder head proximate to the combustion chamber. The inner seal is configured to isolate an inner face of the outer seal from the combustion chamber. A first compressive strength of the outer seal is greater than a second compressive strength of the inner seal.

In a third embodiment, a method includes reducing, with an inner seal, an annular crevice volume between a cylinder head, a cylinder liner, and an inner face of an outer seal. The method also includes isolating, with the inner seal, the inner face of the outer seal from a combustion chamber. The combustion chamber is defined by the cylinder head and the cylinder liner. A reciprocating engine includes the cylinder head, the cylinder liner, the outer seal, and the inner seal. The outer seal is configured to transfer more of an axial compressive load between the cylinder head and the cylinder liner than the inner seal.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic block diagram of an embodiment of a portion of an engine driven power generation system;

FIG. 2 is a cross-sectional view of an embodiment of a piston positioned within a cylinder liner of an engine;

FIG. 3 is a partial cross-sectional view of an embodiment of the piston, the cylinder liner, and a seal assembly of the engine, taken within line 3-3 of FIG. 2;

FIG. 4 is a partial cross-sectional view of an embodiment of the cylinder liner and the seal assembly, taken within line 3-3 of FIG. 2;

FIG. 5 is a partial cross-sectional view of an embodiment of the cylinder liner and the seal assembly, taken within line 3-3 of FIG. 2; and

FIG. 6 is a partial cross-sectional view of an embodiment of the cylinder liner and the seal assembly, taken within line 3-3 of FIG. 2.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Reciprocating engines (e.g., internal combustion engines) in accordance with the present disclosure may include a piston configured to move linearly (e.g., axially) within a cylinder liner to convert pressure exerted by combustion gases in a combustion chamber on the piston into a rotating motion to power one or more loads. A piston cylinder assembly includes the cylinder head, the cylinder liner, and the reciprocating piston. The combustion chamber is defined by at least a cylinder head, the cylinder liner, and the piston of the piston cylinder assembly. A seal between the cylinder head and the cylinder liner seals the combustion gases within the combustion chamber, thereby directing the expansion of the combustion gases to act on the piston. The seal includes an inner seal (e.g., annular seal) proximate to the combustion chamber and an outer seal (e.g., annular seal) proximate to an outer wall (e.g., outer annulus) of the cylinder liner. The inner seal may reduce a crevice volume (e.g., annular volume) between the cylinder head and the cylinder liner. As may be appreciated, the crevice volume about a combustion chamber may result in incomplete combustion of portions of the air and fuel. That is, portions of the air and/or the fuel may be caught within the crevice volume and not combust during the combustion cycle of the piston cylinder assembly. These incomplete combustion by-products may be released from the crevice volume and exhausted from the reciprocating engine during the exhaust cycle of the piston cylinder assembly. Accordingly, reducing the crevice volume may increase combustion efficiency and decrease emissions of the reciprocating engine. The inner seal may fill at least 10, 20, 30, 40, 50, 60, 70, 80, or 90 percent of the crevice volume between the cylinder head, the cylinder liner, and the inner face of the outer seal.

Some loads on the cylinder head and cylinder liner of the piston cylinder assembly are transferred through a flange (e.g., annular flange) of the cylinder liner to a support (e.g., an engine block) of the reciprocating engine. The flange extends radially outward from the combustion chamber, such as from an inner wall (e.g., inner annular wall) to an outer wall (e.g., outer annulus) of the cylinder liner. Loads transferred to the flange near the inner wall induce bending moments on the flange. Accordingly, transferring more of the load from the cylinder head through the outer seal and less of the load through the inner seal may reduce bending moments on the flange, thereby increasing the longevity of the cylinder liner. The inner seal may be a softer material than the material of the outer seal, thereby facilitating the increased axial load transfer through the outer seal relative to the inner seal. For example, a ratio of the compressive strength of the outer seal to the compressive strength of the inner seal may be approximately 3:2, 2:1, 3:1, 4:1, 5:1, 10:1, 20:1, or more based at least in part on a design of the reciprocating engine. Additionally, or in the alternative, the inner seal may be a softer material than the material of the cylinder head and the flange. For example, a ratio of the compressive strength of the cylinder head or the flange to the compressive strength of the inner seal may be approximately 2:1, 3:1, 5:1, 10:1, 20:1, 50:1, or more. As described in detail below, the inner seal may include a brazing material. A brazing material may be heated such that the brazing material at least partially melts and wets (e.g., bonds) with the components of the joint without melting the components. For example, the brazing material may wet with the components of the joint via capillary action. The brazing material may wet with the cylinder head and the cylinder liner proximate to the combustion chamber, thereby reducing the crevice volume and sealing the inner face of the outer seal from the combustion gases. Utilizing a brazing material for the inner seal may increase a corrosion resistance and erosion resistance of the inner seal. Additionally, or in the alternative, the brazing material may have a greater longevity under exposure to combustion temperatures than elastomeric inner seals, brass crush rings, or other inner seals.

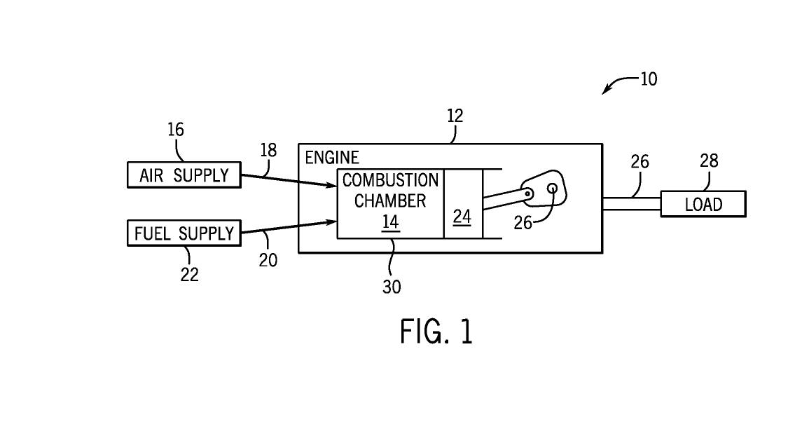

Turning to the drawings, FIG. 1 illustrates a block diagram of an embodiment of a portion of an engine driven power generation system 10. As described in detail below, the system 10 includes an engine 12 (e.g., a reciprocating internal combustion engine) having one or more combustion chambers 14 (e.g., 1, 2, 3, 4, 5, 6, 7, 8, 10, 12, 14, 16, 18, 20, or more combustion chambers 14). Each combustion chamber 14 is defined by a cylinder 30 and a piston 24 reciprocating in the cylinder 30. An oxidant supply 16 is configured to provide a pressurized oxidant 18, such as air, oxygen, oxygen-enriched air, oxygen-reduced air, or any combination thereof, to each combustion chamber 14. The combustion chamber 14 is also configured to receive a fuel 20 (e.g., a liquid and/or gaseous fuel) from a fuel supply 22. A mixture (e.g., fuel-air mixture) of the oxidant 18 and the fuel 20 ignites and combusts within each combustion chamber 14. The hot pressurized combustion gases cause a piston 24 adjacent to each combustion chamber 14 to move linearly within the cylinder 30 and convert pressure exerted by the gases into a rotating motion, thereby causing a shaft 26 to rotate. Further, the shaft 26 may be coupled to a load 28, which is powered via rotation of the shaft 26. For example, the load 28 may be any suitable device that may generate power via the rotational output of the system 10, such as an electrical generator. Additionally, although the following discussion refers to air as the oxidant 18, any suitable oxidant may be used with the disclosed embodiments. Similarly, the fuel 20 may be any suitable fuel, such as natural gas, associated petroleum gas, hydrogen, propane, biogas, sewage gas, syngas, landfill gas, coal mine gas, diesel, gasoline, kerosene, or fuel oil for example.

The system 10 disclosed herein may be adapted for use in stationary applications (e.g., in industrial power generating engines) or in mobile applications (e.g., in automobiles or aircraft). The cylinders 30 may include cylinder liners that are separate from an engine block. For example, steel liners may be utilized with an aluminum engine block. The engine 12 may be a two-stroke engine, three-stroke engine, four-stroke engine, five-stroke engine, or six-stroke engine. The engine 12 may also include any number (e.g., 1-24) of combustion chambers 14, pistons 24, and associated cylinders 30 or cylinder liners. For example, the system 10 may include a large-scale industrial reciprocating engine having 4, 6, 8, 10, 16, 24 or more pistons 24 reciprocating in cylinders 30 or cylinder liners. In such cases, the cylinders 30, cylinder liners, and respective the pistons 24 may have a diameter of between approximately 10-35 centimeters (cm), 12-18 cm, or about 13.5 to 15 cm. In certain embodiments, the piston 24 may be a steel piston or an aluminum piston with an Ni-Resist ring insert in a top ring groove of the piston 24. In some embodiments, the system 10 may generate power ranging from 10 kW to 10 MW. Additionally, or in the alternative, the operating speed of the engine may be less than approximately 1800, 1500, 1200, 1000, 900, 800, or 700 RPM.

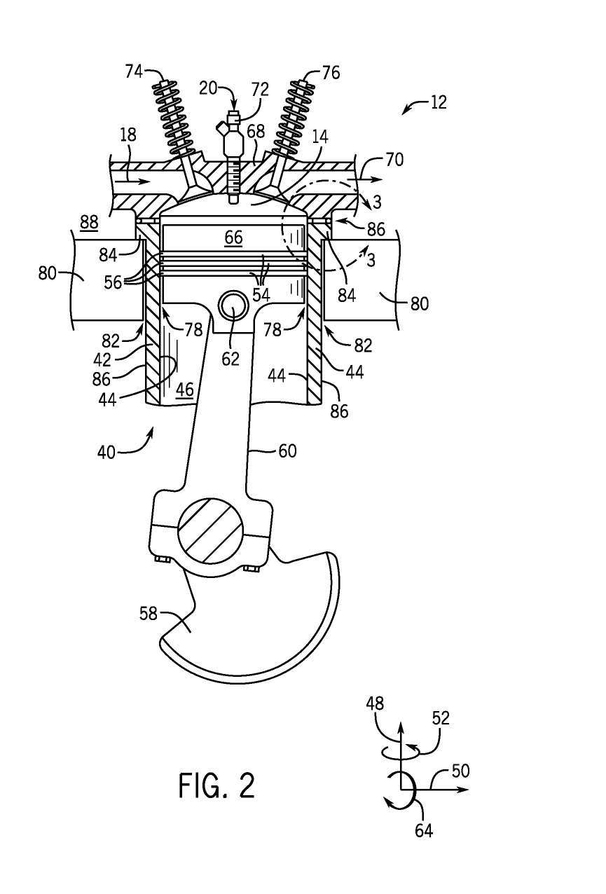

FIG. 2 is a partial side cross-sectional view of an embodiment of a piston cylinder assembly 40 having a piston 24 disposed within a cylinder liner 42 (e.g., an engine cylinder 30) of the reciprocating engine 12. The cylinder liner 42 has an inner annular wall 44 defining a cylindrical cavity 46. Directions relative to the engine 12 may be described with reference to an axial axis or direction 48, a radial axis or direction 50, and a circumferential axis or direction 52. The piston 24 may include one or more grooves 54 (e.g., annular grooves) extending circumferentially (e.g., in the circumferential direction 52) about the piston 24. One or more rings 56 (e.g., annular seal rings or piston rings) may be positioned in one or more respective grooves 54. The one or more rings 56 may be configured to expand and contract in response to high temperatures and high pressure combustion gases during operation of the system 10 and relatively cool temperatures when the system 10 is shut down. It should be understood that the one or more grooves 54 and the corresponding one or more rings 56 may have any of a variety of configurations. For example, one or more of the grooves 54 and/or corresponding rings 56 may have different configurations, shapes, sizes, and/or functions.

As shown, the piston 24 is attached to a crankshaft 58 via a connecting rod 60 and a pin 62. The crankshaft 58 translates the reciprocating linear motion of the piston 24 along the axial axis 48 into a rotating motion 64. The combustion chamber 14 is positioned adjacent to a top land 66 of the piston 24 and a cylinder head 68. The cylinder head 68 distributes the air 18 and the fuel 20 to the combustion chamber 14, and exhausts combustion products 70 from the combustion chamber 14. For example, one or more fuel injectors 72 provides the fuel 20 to the combustion chamber 14, and one or more valves 74 (e.g., intake valves) controls the delivery of air 18 to the combustion chamber 14. An exhaust valve 76 controls discharge of combustion products 70 (e.g., exhaust gas) from the engine 12. However, it should be understood that any suitable elements and/or techniques may be utilized for providing fuel 20 and air 18 to the combustion chamber 14 and/or for discharging the exhaust gas 70.

In operation, combustion of the fuel 20 with the air 18 in the combustion chamber 14 causes the piston 24 to move in a reciprocating manner (e.g., back and forth) in the axial direction 48 within the cavity 46 of the cylinder liner 42. As the piston 24 moves, the crankshaft 58 rotates (e.g., in direction 64) to power the load 28 (shown in FIG. 1), as discussed above. A clearance 78 (e.g., a radial clearance defining an annular space) is provided between the inner wall 44 of the cylinder liner 42 and the piston 24. The one or more rings 56 may contact the inner wall 44 of the cylinder liner 42 to retain the fuel 20, the air 18, and a fuel-air mixture within the combustion chamber 14. Additionally, or in the alternative, the one or more rings 56 may facilitate maintenance of a suitable pressure within the combustion chamber 14 to enable the expanding hot combustion products 70 to cause the piston 24 to move along the axial axis 48 prior to expulsion through the exhaust valve 76 in a subsequent piston cycle.

The cylinder liner 42 extends in the axial direction 48 through a support structure 80 (e.g., engine block). The cylinder liner 42 may be suspended within an opening 82 or cylindrical bore of the support structure 78 by a flange 84 proximate to the cylinder head 68. The flange 84 extends radially between the inner wall 44 and an outer wall 86 of the cylinder liner 42. In some embodiments, the flange 84 is an annular flange about the liner 42. Axial loads (e.g., compressive forces) are transferred between the cylinder head 68 and the support structure 80 through the flange 84. As discussed in detail below, a seal assembly 86 is arranged between the flange 84 and the cylinder head 68. The seal assembly 86 has multiple uses: to transfer loads between the cylinder head 68 and the flange 84, and to isolate the combustion chamber 14 from an external environment 88.

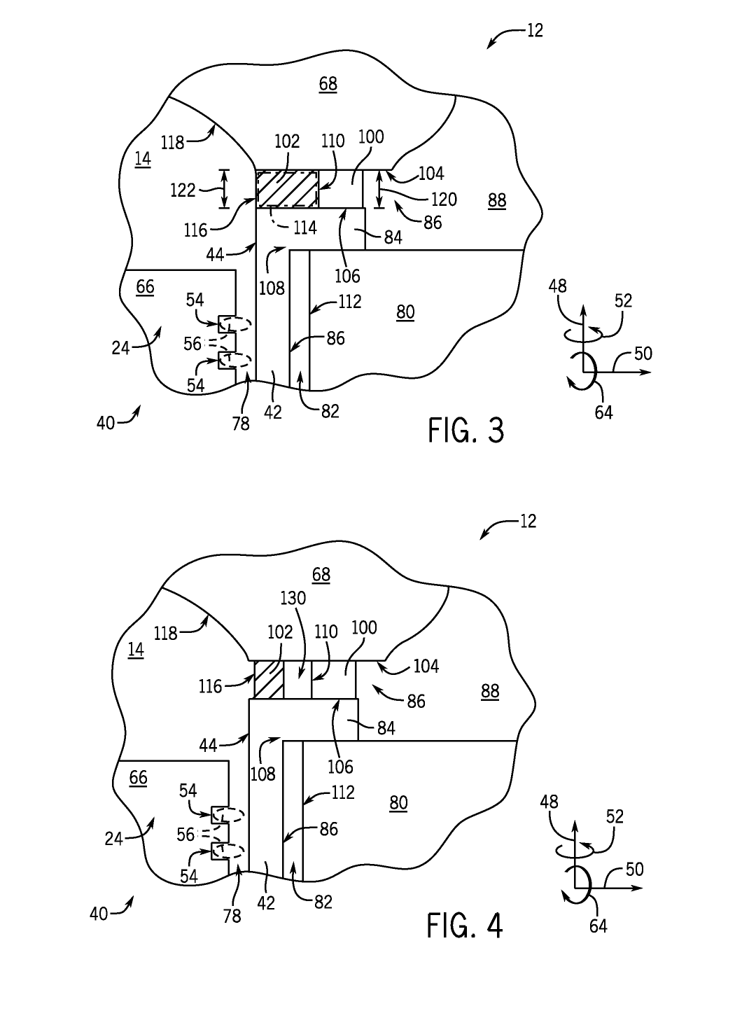

FIG. 3 is a partial cross-sectional view of an embodiment of the cylinder liner 42, the cylinder head 68, and the seal assembly 86 of the engine 12, taken within line 3-3 of FIG. 2. The seal assembly 86 includes an outer seal 100 (e.g., annular seal) and an inner seal 102 (e.g., annular seal). The outer seal 100 interfaces with a first face 104 (e.g., bottom face or axially facing surface) of the cylinder head 68 and a second face 106 (e.g., top face or axially facing surface) of the flange 84. In some embodiments, the outer seal 100 helps to isolate the combustion chamber 14 from the external environment 88, thereby sealing the air 18, fuel 20, and combustion products 70 within the combustion chamber 14 during combustion. The outer seal 100 is axially positioned between the support structure 80 and the cylinder head 68 in the axial direction 48. The outer seal 100 is arranged radially between the cylinder head 68 and the flange 84 to enable the outer seal 100 to directly transfer loads between the cylinder head 68 and the support structure 80 without inducing significant bending moments in the flange 84. Materials of the outer seal 100 may include, but are not limited to, steel alloys (e.g., stainless steel), titanium alloys, fiber materials, ceramic materials, nickel and other non-ferrous alloys, or any combination thereof. In some embodiments, the outer seal 100 has a greater hardness than the inner seal 102, and the outer seal 100 has a greater compressive strength than the inner seal 102. The greater hardness and/or compressive strength may enable the outer seal 100 to transfer more or substantially the entire load transferred between the cylinder head 68 and the support structure 80, relative to the inner seal 102. As may be appreciated, loads applied to the flange 84 of the cylinder liner 42 near the inner wall 44 may induce bending moments in the flange 84 and may increase a stress concentration within the flange 84, such as at a point 108. In some embodiments, the outer seal 100 is positioned in the radial direction 50 such that an inner face 110 of the outer seal 100 is radially aligned with or is radially outside of an inner wall 112 of the support structure 80.

An annular crevice volume 114, shown in dashed lines, is defined herein as a space between the first face 104 of the cylinder head 68, the second face 106 of flange 84 of the cylinder liner 42, the inner wall 44 of the cylinder liner 42, and the inner face 110 of the outer seal 100. The annular crevice volume 114 extends in the circumferential direction 52 about the combustion chamber 14. As discussed in detail below, the inner seal 102 is configured to reduce the annular crevice volume 114. Without the inner seal 102, air 18 and/or fuel 20 may enter the annular crevice volume 114 and fail to react (e.g., combust) during a piston cycle, thereby reducing the combustion efficiency of the piston cylinder assembly 40. In particular, whereas the air 18 and/or the fuel 20 that enters other crevice volumes proximate to the combustion chamber 14 may eventually combust prior to being expelled from the combustion chamber 14, the proximity of the annular crevice volume 114 to the one or more exhaust valves 76 may increase the probability that the air 18 and/or the fuel 20 that enters the annular crevice volume 114 will be expelled from the combustion chamber 14 without being combusted.

The inner seal 102 is configured to at least partially or completely fill the annular crevice volume 114, thereby reducing the available space for the air 18 and/or the fuel 20 to be retained and increasing the combustion efficiency of the piston cylinder assembly 40. In some embodiments, an inner face 116 of the inner seal 102 interfaces with (e.g., is flush with) the inner wall 44 of the cylinder liner 42 and/or an inner wall 118 of the cylinder head 68. The inner seal 102 may fill between 10 to 100 percent, 25 to 99 percent, 50 to 95 percent, or 75 to 90 percent of the annular crevice volume 114. The inner seal 102 interfaces with the first face 104 of the cylinder head 68, the second face 106 of the flange 84, or any combination thereof. The inner seal 102 is positioned in the axial direction 48 between the cylinder head 68 and the flange 84, and the inner seal 102 may be positioned in the radial direction 50 substantially inside the inner wall 112 of the support structure 80 and the outer seal 100. The inner seal 102 may be a material that is softer (lower compressive strength) than the outer seal 100. For example, the material of the inner seal 102 may be a brazing alloy including, but not limited to, a silver brazing alloy, a bronze brazing alloy, a palladium-based brazing alloy, a gold-based brazing alloy, a copper-based alloy, or a nickel-based brazing alloy. Accordingly, the compressive strength of the seal assembly 86 increases in the radial direction 50 outward from the combustion chamber 14 from the inner seal 102 to the outer seal 100. The inner seal 102 is configured to transfer less of the load between the cylinder head 68 and the flange 84 than the outer seal 100, thereby reducing bending moments in the flange 84 and reducing stress concentrations at the point 108. In some embodiments, the inner seal 102 is configured to transfer substantially none of the load between the cylinder head 68 and the flange 84. For example, the inner seal 102 may transfer less than 25, 20, 15, 10, or 5 percent of the axial load between the cylinder head 68 and the flange 84. Additionally, or in the alternative, a first thickness 120 of the outer seal 100 may be substantially equal to a second thickness 122 of the inner seal 100. That is, rather than using differences in the thicknesses of the outer and inner seals 100, 102 to manage the load distribution across the seal assembly 86, differences in the compressive strengths of the outer and inner seals 100, 102 may facilitate the transfer of axial loads between the cylinder head 68 and the flange 84 to be primarily through the outer seal 100.

In some embodiments, the inner seal 102 is configured to isolate the inner face 110 from the combustion chamber 14. That is, the inner seal 102 may isolate the outer seal 100 from the air 18, the fuel 20, the combustion products 70, or any combination thereof. The inner seal 102 may interface with the inner face 110 of the outer seal 100, as shown in FIG. 3. In some embodiments, as shown in FIG. 4, the inner seal 102, the outer seal 100, the cylinder head 68, and the flange 84 may define a sealed cavity 130 that is isolated from the combustion chamber 14 and the external environment 88. As may be appreciated, the inner seal 100 and the cavity 130 reduce the annular crevice volume 114, thereby increasing the combustion efficiency of the piston cylinder assembly 40.

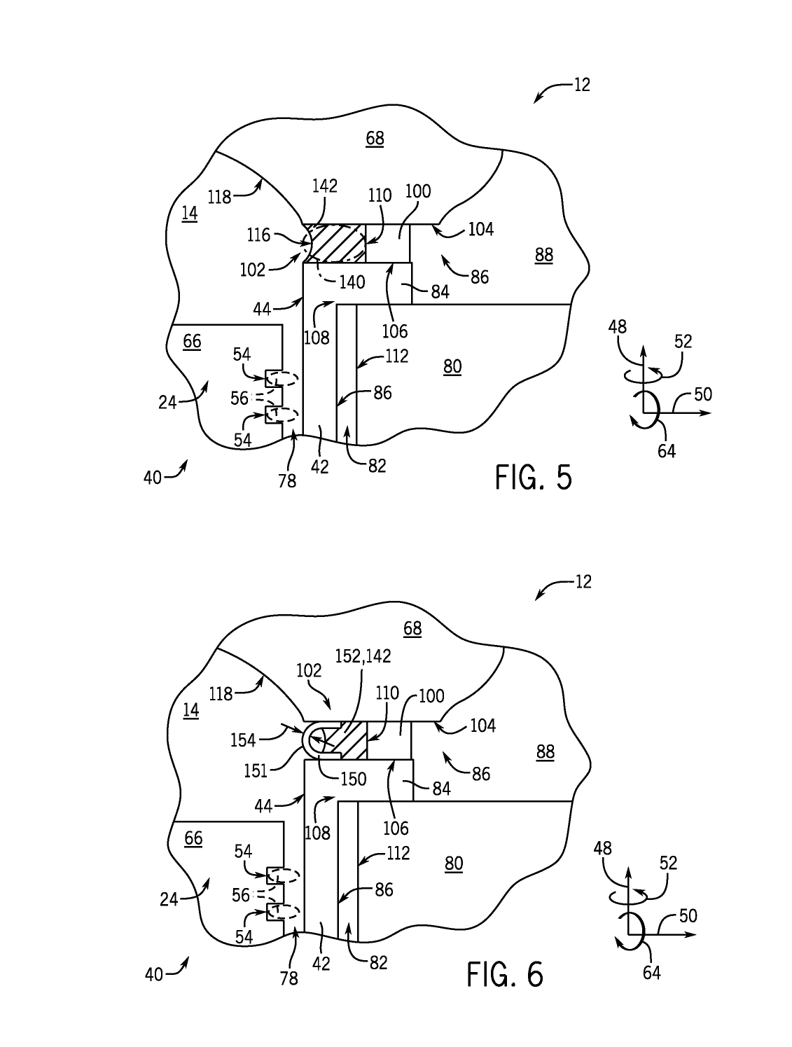

In some embodiments, the inner seal 102 may include a braze material. FIG. 5 illustrates a partial cross-sectional view of an embodiment of the seal assembly 86, taken within line 3-3 or FIG. 2. The inner seal 102 of the seal assembly 86 includes a braze material. For example, a brazing ring 140, shown in dashed lines, may be disposed in the annular crevice volume 114 between the cylinder head 68 and the flange 84. The term brazing ring 140 utilized herein is not limited to an annular component of a braze material. For example, the brazing ring 140 may be multiple sections of a braze material disposed in the annular crevice volume 114. Additionally, or in the alternative, the brazing ring 140 may be formed utilizing a filler rod of a braze material. Upon heating the brazing ring 140 to a brazing temperature, the brazing ring 140 wets (e.g., fixedly bonds) with the first face 104 of the cylinder head 68 and with the second face 106 of the flange 84, thereby forming a brazed seal 142. The brazed seal 142 of the inner seal 102 may be the only portion of the seal assembly 86 that bonds with the cylinder head 68 and the flange 84. In some embodiments, the brazing ring 140 wets with the inner face 110 of the outer seal 100. Where the brazing ring 140 does not interface with the inner face 110 of the outer seal 100, the brazing ring 140 forms the sealed cavity (see FIG. 4). The inner face 116 of the brazed seal 142 may be curved and/or flush with the inner walls 44, 118 of the cylinder liner 42 and the cylinder head 68. In some embodiments, the inner face 116 of the brazed seal 142 is radially offset from the inner wall 44 of the cylinder liner 42, such that the inner face 116 extends into the combustion chamber 14 or is recessed in the annular crevice volume 114.

The material for the inner seal 102 (e.g., brazing ring 140) may be selected for one or more characteristics including, but not limited to, corrosion resistance, bond strength with the materials of the cylinder head 68 and the flange 84, solidus temperature, liquidus temperature, or compressive strength, or any combination thereof. For example, the material may have a desired corrosion resistance when exposed to the air 18, the fuel 20, and/or the combustion products 70 at combustion temperatures (e.g., 540 to 870 degrees C.). Additionally, or in the alternative, the material of the inner seal 102 may be selected to have a compressive strength less than the compressive strength of the outer seal 100, thereby enabling the outer seal 100 to transfer more of the axially compressive loads between the cylinder head 68 and the flange 84 than the inner seal 102. For example, the material of the outer seal 100 may be a stainless steel alloy, and the material of the inner seal 102 may be a nickel-based brazing alloy. Furthermore, the material of the inner seal 102 may be selected to enable the inner seal 102 to bond with the cylinder head 68 and the flange 84 to isolate the inner face 110 of the outer seal 100 from the combustion chamber 14 through a range of operating temperatures (e.g., 20 to 900 degrees C.).

In some embodiments, the inner seal 102 may include a nickel-based or iron-based brazing ring 140 with at least 23 weight percent chromium, at least 6.5 weight percent silicon, and at least 4.5 weight percent phosphorus. The composition of the brazing ring 140 may be selected such that the solidus temperature of the brazing ring 140 is greater than approximately 970 degrees C. and the liquidus temperature of the brazing ring 140 is less than approximately 1135 degrees C. In some embodiments, the material of the brazing ring 140 may be selected to enable the brazed seal 142 to maintain the inner seal 102 during normal operating combustion temperatures. Accordingly, the solidus and liquidus temperatures of the brazing ring 140 utilized in a stoichiometric combustion reciprocating engine 12 may be higher than the solidus and liquidus temperatures of the brazing ring 140 utilized in a non-stoichiometric (e.g., lean burn) reciprocating engine 12.

In some embodiments, the inner seal 102 may be include, but are not limited to, a brazing alloy listed in Tables 1-5, available from Johnson Matthey Metal Joining of Royston, England. As may be appreciated, nickel-based, copper-based, and palladium-based brazing alloys may have lower costs than gold-based and silver-based brazing alloys. In some embodiments, gold-based and silver-based brazing alloys may increase ductility of the inner seal 102. Moreover, the material of the inner seal 102 may be selected based at least in part on the melting range of the brazing alloy. For example, the brazing alloys listed in Tables 1-5 have melting temperatures between approximately 600 to 1230 degrees C.

TABLE 1
Nickel-based Brazing Alloy

| | | | | | | Melting Range |
|---|---|---|---|---|---|---|
| | Ni | Cr | Fe | B | Other | (° C.) |
| HTN1 | Bal | 14 | 4.5 | 3.1 | Si 4.5; Co 0.7 | 980-1060 |
| HTN1A | Bal | 14 | 4.5 | 3.1 | Si 4.5 | 980-1070 |
| HTN2 | Bal | 7 | 3.0 | 3.1 | Si 4.5 | 970-1000 |
| HTN3 | Bal | — | 0.5 | 3.1 | Si 4.5 | 980-1040 |
| HTN4 | Bal | — | 1.5 | 1.8 | Si 3.5 | 980-1070 |
| HTN5 | Bal | 19 | — | — | Si 10.1 | 1080-1135 |
| HTN6 | Bal | — | — | — | P 11 | 875 |
| HTN7 | Bal | 14 | — | — | P 10.1 | 890 |

TABLE 2
Copper-based Brazing Alloy

| | Cu | Ni | Sn | Other | Melting Range (° C.) |
|---|---|---|---|---|---|
| 92/8 | 91.75 | — | 8 | 0.25 P | 882-1027 |
| 97/3 | 97 | — | 3 | — | 980-1070 |
| 96/4 | 96 | — | 4 | — | 950-1060 |
| CU 511 | 80 | — | 20 | — | 800-980 |
| CU 512 | 88 | — | 12 | — | 800-890 |
| Copper | 99.9 | — | — | — | 1085 |
| Copper | 99.95 | — | — | — | 1085 |
| CU510/513 | 99.9 | — | — | — | 1085 |
| CU 535/557 | 99.4 | 0.6 | — | — | 1085 |
| CU503 | 32 | — | — | 68 Cu₂O | 1085 |
| CU521 | 32 | .6 | — | 68 Cu₂O | 1085 |

TABLE 3
Palladium-based Brazing Alloy

| | Pd | Ag | Cu | Ni | Melting Range (° C.) |
|---|---|---|---|---|---|
| Pallabraze 810 | 5 | 68.5 | 26.5 | — | 807-810 |
| Pallabraze 840 | 10 | 67.5 | 22.5 | — | 834-840 |
| Pallabraze 850 | 10 | 58.5 | 31.5 | — | 824-850 |
| Pallabraze 880 | 15 | 65 | 20 | — | 856-880 |
| Pallabraze 900 | 20 | 52 | 28 | — | 876-900 |
| Pallabraze 950 | 25 | 54 | 21 | — | 901-950 |
| Pallabraze 1010 | 5 | 95 | — | — | 970-1010 |
| Pallabraze 1090 | 18 | — | 82 | — | 1080-1090 |
| Pallabraze 1225 | 30 | 70 | — | — | 1150-1225 |
| Pallabraze 1237 | 60 | — | — | 40 | 1237-1237 |

TABLE 4
Gold-based Brazing Alloy

| | Au | Cu | Ni | Other | Melting Range (° C.) |
|---|---|---|---|---|---|
| Orobraze 845 | 60 | 20 | — | 20 Ag | 835-845 |
| Orobraze 910 | 80 | 19 | — | 1 Fe | 908-910 |
| Orobraze 940 | 62.5 | 37.5 | — | — | 930-940 |
| Orobraze 950 | 82 | — | 18 | — | 950-950 |
| Orobraze 970 | 50 | 50 | — | — | 955-970 |
| Orobraze 990 | 75 | — | 25 | — | 950-990 |
| Orobraze 998 | 37.5 | 32.5 | — | — | 980-998 |
| Orobraze 1005 | 35 | 65 | — | — | 970-1005 |
| Orobraze 1018 | 30 | 70 | — | — | 996-1018 |
| Orobraze 1030 | 35 | 62 | 3 | — | 1000-1030 |
| Orobraze 1040 | 70 | — | — | 30 Ag | 1030-1040 |

TABLE 5
Silver-based Brazing Alloy

| | Ag | Cu | In | Other | Melting Range (° C.) |
|---|---|---|---|---|---|
| Silver | 99.9 | — | — | — | 960 |
| Silver-Cu | 72 | 28 | — | — | 778 |
| Eutectic | | | | | |
| IN 10 | 63 | 27 | 10 | — | 685-730 |
| IN 15 | 61 | 24 | 15 | — | 630-705 |
| RTSN | 60 | 30 | — | 10 Sn | 602-718 |
| 85/15 Ag/Mn | 85 | — | — | 15 Mn | 960-970 |
| DHE310 | 54 | 40 | — | 5 Zn; 1 Ni | 718-857 |
| Argo-Braze 7 | 7 | 85 | — | 8 Sn | 662-984 |
| AMS 4765 | 56 | 42 | — | 2 Ni | 771-893 |
| AMS4774A | 63 | 28.5 | — | 2.5 Ni | 691-802 |

The brazing ring 140 of the inner seal 102 of the seal assembly 86 wets (e.g., bond) with the first face 104 of the cylinder head 68 and/or the second face 106 of the flange 84 at the brazing temperature. In some embodiments, the material of the brazing ring 140 is selected such that the brazing temperature is within a range of combustion temperatures that the inner seal 102 is exposed to during operation of the piston cylinder assembly 40. For example, during initial operation of the reciprocating engine 12, the combustion of the air 18 and the fuel 20 in the combustion chamber 14 heats the brazing ring 140 to the brazing temperature (e.g., approximately 800 degrees C.). The initial operation of the reciprocating engine 12 may be controlled to a greater temperature than a typical operating temperature, such that the brazing ring 140 is heated to wet (e.g., bond) with the cylinder head 68 and the flange 84 in the desired position. Upon formation of the brazed seal 142, the reciprocating engine 12 may be controlled to operate at the typical operating temperature, thereby retaining the brazed seal in the annular crevice volume. In some embodiments, the material of the brazing ring 140 is selected such that the brazing temperature is greater than a range of combustion temperatures that the inner seal 102 is exposed to during operation of the piston cylinder assembly 40. Accordingly, prior to assembly of the cylinder liner 42 with the support structure 80, the brazing ring 140 may be inserted in the desired position between the cylinder head 68 and the flange 84 of the cylinder liner 42, then the brazing ring 140 may be heated to the brazing temperature. For example, prior to insertion of the cylinder liner 42 into the opening 82, the brazing ring 140 may be heated to the brazing temperature via a torch, an inductive process, or any combination thereof. Utilizing a brazing ring 140 with a brazing temperature greater than the range of combustion temperatures of the engine 12 may enable the brazed seal 142 to endure sustained operation at the combustion temperatures without melting.

FIG. 6 illustrates a cross-sectional view of the seal assembly 86 of the piston cylinder assembly 40, taken within line 3-3 of FIG. 2. FIG. 6 illustrates an embodiment of the seal assembly 86 in which the inner seal 102 includes a shield 150 (e.g., an annular shielding ring having a U-shaped or C-shaped cross-section 151). The shield 150 is disposed in the annular crevice volume 114 inside the outer seal 100 in the radial direction 50. The shield 150 may be a heat resistant material that may readily endure combustion temperatures. For example, the shield may include, but is not limited to, steel. In some embodiments, the shield 150 at least partially isolates an inner sealant 152 (e.g., brazed seal 142) from the combustion chamber 14. For example, the shield 150 may at least partially isolate the inner sealant 152 from potentially corrosive materials, such as the fuel 20 or the combustion products 70. The shield 150 interfaces with the first surface 104 of the cylinder head 68 and the second surface 106 of the flange 84. A thickness 154 and/or a shape of the shield 150 are selected to reduce the load transferred by the shield 150 between the cylinder head 68 and the flange 84, thereby reducing the stress concentration at the point 108. While the shield 150 illustrated in FIG. 6 has a U-shape 151 (e.g., an outwardly curved cross-section), other embodiments of the shield 150 may include, but are not limited, to an I-shape, a J-shape, an L-shape, an M-shape, an S-shape, a T-shape, a V-shape, an X-shape, and so forth. That is, the shield 150 is configured to shield the inner sealant 152 and/or the outer seal 100 from the combustion chamber 14, and the shield 150 is not configured to transfer an axial load (e.g., compressive load) between the cylinder head 68 and the flange 84.

The shield 150 may facilitate retaining the sealant material 152 within the annular crevice volume 114. Additionally, or in the alternative, the sealant material 152 may interface with the shield 150 and another surface (e.g., first surface 104, second surface 106, inner surface 110), thereby retaining the shield 150. For example, the sealant material 152 may be the brazed seal 142. As discussed above, the inner seal 102 is configured to reduce the annular crevice volume 114, and may be configured to isolate the inner face 110 of the outer seal 100 from the combustion chamber 14. Furthermore, the inner seal 102 is configured to transfer less of the load between the cylinder head 68 and the flange 84 than the outer seal 100, thereby reducing bending moments in the flange 84 and reducing stress concentrations at the point 108.

As discussed herein, a method of utilizing the seal assembly 86 may include reducing an annular crevice volume 114 with an inner seal 102 of the seal assembly 86. Additionally, or in the alternative, the method of utilizing the seal assembly 86 may include isolating, with the inner seal 102, the inner face 110 of the outer seal from the combustion chamber 14. The materials of the inner seal 102 and the outer seal 100 are selected to facilitate transferring axial loads (e.g., compressive loads) between the cylinder head 68 and support structure, via the flange 84 of the cylinder liner 42, primarily through the outer seal 100. That is, the outer seal 100 is configured to transfer more of the load between the cylinder head 68 and the cylinder liner 42 than the inner seal 102.

Technical effects of the embodiments discussed herein include increasing the combustion efficiency of the air and the fuel in the combustion chamber via reducing the crevice volume. The outer seal is configured to transfer more of the axial compressive load between the cylinder head and the cylinder liner than the inner seal, thereby reducing stress that may be otherwise concentrated at a point in the flange of the cylinder liner due to induced bending moments. In some embodiments, the inner seal isolates the inner face of the outer seal from the combustion chamber. Moreover, in some embodiments, a shield of the inner seal may isolate a sealant material of the inner seal from the combustion chamber.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A reciprocating engine, comprising:
a cylinder head;
a cylinder liner comprising:
an inner wall extending circumferentially around a cavity within the cylinder liner;
an outer wall extending circumferentially around the inner wall; and
a flange proximate to the cylinder head, wherein the flange extends radially between the inner wall and the outer wall;
an outer seal proximate to the outer wall and disposed axially between the flange of the cylinder liner and the cylinder head, wherein the outer seal interfaces with the flange and the cylinder head; and
an inner seal proximate to the inner wall and disposed axially between the flange of the cylinder liner and the cylinder head, wherein the inner seal interfaces with at least one of the flange and the cylinder head, and the outer seal is configured to transfer more of an axial compressive load between the cylinder head and the flange than the inner seal.

2. The reciprocating engine of claim 1, wherein the inner seal comprises a brazing ring, wherein combustion within the cavity during initial operation of the reciprocating engine is configured to wet the brazing ring with the flange and the cylinder head.

3. The reciprocating engine of claim 1, wherein the inner seal comprises a brazing ring configured to wet with the flange and the cylinder head at temperatures at or greater than a peak combustion temperature.

4. The reciprocating engine of claim 1, wherein the outer seal comprises a steel, a ceramic, or any combination thereof.

5. The reciprocating engine of claim 1, wherein the inner seal interfaces with an inner face of the outer seal, the cylinder head, and a top surface of the flange.

6. The reciprocating engine of claim 1, wherein the inner seal comprises a shield and a braze material, the braze material is radially disposed between the shield and the outer seal, and the shield is configured to isolate the braze material from combustion gases within the cavity during operation of the reciprocating engine.

7. The reciprocating engine of claim 1, wherein the inner seal comprises a brazing ring, and the brazing ring comprises at least 23 weight percent chromium and at least 6 weight percent silicon, wherein a solidus temperature of the brazing ring is greater than approximately 970 degrees C., and a liquidus temperature of the brazing ring is less than approximately 1135 degrees C.

8. The reciprocating engine of claim 1, wherein a first compressive strength of the outer seal is greater than a second compressive strength of the inner seal.

9. The reciprocating engine of claim 1, wherein a first thickness of the outer seal is approximately equal to a second thickness of the inner seal.

10. A reciprocating engine comprising:
a cylinder head;
a cylinder liner comprising a flange proximate to the cylinder head, wherein the cylinder liner extends circumferentially around a combustion chamber, and the cylinder head defines an end of the combustion chamber;
an outer seal disposed between the flange of the cylinder liner and the cylinder head, wherein the outer seal is configured to transfer an axial compressive load between the cylinder head and the cylinder liner; and
an inner seal disposed between the cylinder liner and the cylinder head proximate to the combustion chamber, wherein the inner seal is configured to isolate an inner face of the outer seal from the combustion chamber, and a first compressive strength of the outer seal is greater than a second compressive strength of the inner seal.

11. The reciprocating engine of claim 10, comprising an annular crevice volume between the cylinder head, the cylinder liner, and the inner face of the outer seal, wherein the inner seal is configured to fill at least 50 percent of the annular crevice volume.

12. The reciprocating engine of claim 10, wherein the inner seal comprises a brazing ring.

13. The reciprocating engine of claim 12, wherein the inner seal comprises a shield configured to isolate the brazing ring from the combustion chamber.

14. The reciprocating engine of claim 10, wherein an outer face of the inner seal, the inner face of the outer seal, the cylinder head, and the flange form a sealed cavity.

15. The reciprocating engine of claim 10, wherein the inner seal comprises a brazing ring, and the brazing ring comprises at least 23 weight percent chromium and at least 6 weight percent silicon.

16. A method comprising:
reducing, with an inner seal, an annular crevice volume between a cylinder head, a cylinder liner, and an inner face of an outer seal; and
isolating, with the inner seal, the inner face of the outer seal from a combustion chamber, wherein the combustion chamber is defined by the cylinder head and the cylinder liner, a reciprocating engine comprises the cylinder head, the cylinder liner, the outer seal, and the inner seal, and the outer seal is configured to transfer more of an axial compressive load between the cylinder head and the cylinder liner than the inner seal.

17. The method of claim 16, wherein the inner seal comprises a brazing ring.

18. The method of claim 17, comprising isolating, with a shield, the brazing ring from the combustion chamber, wherein the inner seal comprises the shield.

19. The method of claim 16, wherein the inner seal interfaces with the cylinder head and a top surface of the flange.

20. The method of claim 16, wherein an outer face of the inner seal, the inner face of the outer seal, the cylinder head, and the cylinder liner form a sealed cavity.
